(19) United States
(12) Patent Application Publication
(10) Pub. No.: US 2005/0178116 A1
(43) Pub. Date: Aug. 18, 2005

(54) Hydraulic control system using load-sensing technology

(76) Inventor: Gottfried Olbrich, Sachsenheim (DE)

Correspondence Address: Martin A Farber, Suite 473, 866 United Nations Plaza, New York, NY, 10017, US

(21) Appl. No.: 10/509,991

(22) PCT Filed: Apr. 4, 2003
(86) PCT No.: PCT/EP03/03537

(30) Foreign Application Priority Data
Apr. 12, 2002 (DE) 10216119.4

(51) Int. Cl. F16D 31/02

(52) U.S. Cl. 60/420

(57) ABSTRACT

Hydraulic control arrangement using load-sensing technology A hydraulic control arrangement using load-sensing technology has a first directional control valve, via which pressure medium can be supplied to a first hydraulic consumer, and with at least one further directional control valve, via which pressure medium can be supplied to a further hydraulic consumer. The further control valve is preferably combined with the first directional control valve to form a valve block, with a load indication line, via which a control side of the load-sensing regulating valve can be acted upon by a control pressure dependent on the highest load pressure of the actuated hydraulic consumers. A pilot valve arrangement limits control pressure to a limit pressure and can be set from a high first limit pressure to a lower second limit pressure.

The invention precedes from a hydraulic control arrangement using load-sensing technology, which, according to the preamble of patent claim 1, has a first directional control valve, via which pressure medium can be supplied to a first hydraulic consumer, at least one further directional control valve, via which pressure medium can be supplied to a further hydraulic consumer and which is preferably combined with a first directional control valve to form a valve block, and a load-sensing regulation device.

A hydraulic control arrangement according to the preamble of patent claim 1 is known, for example, from DE 197 15 021 A1. This is a hydraulic control arrangement according to the load-sensing principle, in which a variable displacement pump or a bypass pressure compensator assigned to a fixed displacement pump is set, as a function of a control pressure changing with the highest load pressure of the actuated hydraulic consumers, preferably as a function of the load pressure itself, in each case in such a way that the pump pressure lies above the highest load pressure by the amount of a defined pressure difference, the regulating Δp. For this purpose, the control pressure is supplied via a load indication line to a load-sensing regulating valve which is implemented by a regulating valve of the variable displacement pump or by the bypass pressure compensator. Said load indication line is composed of a number of line segments corresponding to the number of directional control valves. Each directional control valve has an individual indication duct. Changeover valves serve for connecting the individual indication duct carrying the highest pressure to the load indication line and the line segments of the latter to one another.

The pressure medium flows to the hydraulic consumers via adjustable metering diaphragms which are conventionally formed on the control slides of the directional control valves and which are arranged between an inflow line emanating from the variable displacement pump and the hydraulic consumers. Owing to the pressure difference between the highest load pressure and the pump pressure, said pressure difference being independent of the highest load pressure, the speed with which the hydraulic consumer having the highest load pressure is moved depends solely on the throughflow cross section of the corresponding metering diaphragm.

What can be achieved by means of the individual pressure compensators as may be referred to, which precede or follow the metering diaphragms is that the speed of movement of all the simultaneously actuated hydraulic consumers is independent of the load pressure. By means of the individual pressure compensators, the pressure difference across the metering diaphragms belonging to the hydraulic consumers having the lower load pressure is also kept constant, so that the pressure medium quantity flowing to a hydraulic consumer depends only on the throughflow cross section of the respective metering diaphragm. When a metering diaphragm is opened further, a greater pressure medium quantity must flow across it in order to generate the defined pressure difference. The variable displacement pump or the bypass pressure compensator is in each case adjusted in such a way that the required pressure medium quantity is delivered. This is therefore also called on-demand flow regulation.

As shown in DE 197 15 021 A1, the pump, inflow or system pressure in a load-sensing hydraulic control arrangement can be limited to a limit pressure in that a nozzle is provided in the first line segment, connected to the regulating valve, of the load indication line and a pressure limiting valve is connected to the first line segment between said nozzle and the regulating valve. The pump pressure then does not rise above the limit pressure set by means of the pressure limiting valve by more than the regulating Δp. Furthermore, the load pressure with which a hydraulic consumer can be acted upon to the maximum degree can also be set individually. For this purpose, according to DE 197 15 021, a pressure limiting valve is connected, downstream of a nozzle, to the individual indication duct to the corresponding directional control valve section. By means of this pressure limiting valve, the control pressure in the spring space of the individual pressure compensator is limited. To be precise, the pressure compensator closes when the pressure upstream of the metering diaphragm becomes higher than the control pressure increased by the amount of the regulating Δp of the individual pressure compensator. The load pressure can therefore rise only to a pressure which lies above the response pressure of the pressure limiting valve by the amount of the regulating Δp of the individual pressure compensator. For this purpose, however, an individual pressure compensator is necessary in the directional control valve section of the hydraulic consumer.

The aim on which the invention is based is to develop a hydraulic control arrangement which has the features from the preamble of patent claim 1, in such a way that the load pressure for one hydraulic consumer is limited in a cost-effective way to a lower value than for another hydraulic consumer, specifically is limited to the lower value, irrespective of whether the second function is actuated alone or together with the first function. The second function is consequently to be reliably protected from too high a pressure.

The sought-after aim is achieved, according to the invention in that, in the hydraulic control arrangement having the features from the preamble of patent claim 1, the pilot valve arrangement can be set from a high first limit pressure to a lower second limit pressure in the case of a defined pressure occurring in a further line segment of the load indication line, and in that, as seen from the first line segment of the load indication line, the individual indication ducts can be connected to the successive line segments of the load indication line according to falling maximum load pressure of the hydraulic consumers. A control arrangement according to the invention serves for the actuation of two or more groups of one or more hydraulic consumers in each case, the groups differing from one another in different maximum load pressures. As seen from the regulating valve, therefore, the load indication line has located in it, first, the line segments which can be connected via a changeover valve to an individual indication duct to the directional control valve by means of which a hydraulic consumer from the group having the highest maximum load pressure can be controlled. These are then followed by the line segments for the group of hydraulic consumers having the second highest maximum load pressure, then the line segments for the group having the third highest load pressure, and so on and so forth. Conventionally, for reasons of simple bore drilling and having as identical a configuration of the individual directional control valve sections as possible, the sequence in a valve block will also correspond to this sequence, so that, in said valve block, the directional control valve sections for the group of consumers having the highest maximum load pressure are followed by the directional control valve sections for the group having the second highest maximum load pressure. If more than two different maximum load pressures are provided, the directional control valve sections for the group having the third highest maximum load pressure then follow. Then, overall, the directional control valve sections are arranged in the valve block according to falling maximum load pressure. When a hydraulic consumer from a group not having the highest maximum load pressure is actuated, the corresponding line segment of the load indication line is acted upon with the load pressure via the assigned changeover valve. By means of this pressure, the pilot valve arrangement is controlled in such a way that the pressure in the first line segment of the load indication line between the nozzle and the regulating valve cannot overshoot the maximum control pressure corresponding to the lower maximum load pressure, at least when the lower maximum load pressure is reached at the corresponding consumer. If the group comprises a plurality of hydraulic consumers and consequently a plurality of directional control valves and a plurality of line segments of the load indication line, the pressure tap in the foremost line segment, that is to say in that line segment of these line segments which is nearest to the regulating valve, is sufficient, since the pressure passes from line segments located further to the rear into the foremost line segment via one or more changeover valves. In the case of a hydraulic control arrangement according to the invention, no individual pressure compensators are necessary in order to have different maximum load pressures for the hydraulic consumers.

Advantageous refinements of a hydraulic control arrangement according to the invention may be gathered from the subclaims.

In principle, it is conceivable to detect the pressure in a further line segment of the load indication line by means of a pressure sensor and to adjust the pilot valve arrangement electrically. In terms of outlay, however, it seems simpler if, according to patent claim 2, the pilot valve arrangement can be adjusted hydraulically via a control line which is connected to the further line segment of the load indication line.

In terms of space requirement, it seems especially advantageous if, according to patent claim 3, the pilot valve arrangement has a pilot valve which is arranged between the first line segment and a relief line and the response pressure of which can be varied, for example, between two pressure stages. In particular, the pilot valve may be a pressure limiting valve with two pressure stages and with a valve element which is acted upon in the opening direction by the pressure occurring directly at the valve inlet. It is also possible, however, that the valve element of a pilot valve arranged between the first line segment of the load indication line and a relief line or connectable between these is acted upon the opening direction by the pressure on that side of the nozzle which is remote from the regulating valve. The pilot valve will then limit the control pressure in that line segment between the nozzle and the regulating valve to which said pilot valve is connected with its main inlet separate from a control inlet to a pressure lying below the response pressure by the amount of the regulating Δp.

A first possibility for obtaining two pressure stages of the pilot valve is, as specified in patent claim 4, to vary the prestress of a valve spring which acts upon the moveable valve element of the pilot valve in the direction of the closing position counter to a pressure force generated at an active face of the valve element.

For this purpose, preferably, according to patent claim 5, an auxiliary piston is used, via which the prestressing force of the valve spring can be varied between two values defined by a first fixed abutment and a second fixed abutment. The auxiliary piston has an active face which is larger than the active face on the valve element, so that, when the two active faces on the valve element and on the auxiliary piston are acted upon with the same pressure, the auxiliary piston will initially prestress the valve spring to a greater extent, before, with the pressure rising further, the pilot valve opens, and then reliably maintains its position determined by the abutment defining the higher value of the spring prestress. The active face on the auxiliary piston can be relieved of pressure or can be acted upon with pressure as a function of the switching position of a reversing valve, said switching position being determined by the pressure in the further line segment of the load indication line. By reversing valves being used, a very low pressure in the further line segment of the load indication line is sufficient to set the pilot at the low limit pressure.

It is especially advantageous if, according to patent claim 6, the two abutments can be adjusted independently of one another as a result of the rotation of two setscrews. Refinements of the hydraulic control arrangement as claimed in patent claim 5 or 6 which are advantageous particularly in structural terms are found in patent claims 7 to 9. It is in this case especially preferred, inter alia, that the valve spring can be supported at the end remote from the valve element by the auxiliary piston, that is to say this end can be displaced by the auxiliary piston. This seems simpler in structural terms than a basically also possible change in the spring prestress by means of a displacement of a valve seat for the valve element.

The response pressure of a valve, on the valve element of which a pressure force acts in the opening direction or, more generally, a pressure force acts in one direction and a spring force acts in the opposite direction, can not only be varied by a variation of the spring prestress, but also by a variation of the effective active face for the pressure occurring. According to patent claim 10, the latter is achieved, in a pilot valve for the hydraulic control arrangement according to the invention, in a structurally simple way in that the valve element can be acted upon in the opening direction by a pressure occurring in the first line segment of the load indication line and at a first control face, and in that there is a second control face on an auxiliary piston which acts on the valve element and which can be relieved of pressure or can be acted upon with pressure as a function of the switching position of a reversing valve, said switching position being determined by the pressure in the further line segment of the load indication line. Preferably, according to patent claim 11 or 12, the valve element is acted upon in the closing position by a pressure occurring at the second control face, the second control face being smaller than the first control face.

The reversing valve may be a simple and cost-effective 2/2-way directional control valve with a single control edge when, according to patent claim 13, it is arranged in series with a nozzle between the load indication line and a relief line, the control space on the auxiliary piston lying at the connection between the nozzle and the 2/2-way directional control valve. According to patent claim 14, however, the reversing valve may also be a 3/2-way directional control valve which connects a control space on the auxiliary piston to the load indication line in one switching position and to a relief line in the other switching position. There is no control-oil loss stream in any position of the reversing valve here, since the 3/2-way directional control valve separates the load indication line from the relief line in both switching positions.

Directly controlled valves which can be set during operation to response pressures differing in steps are seldom required, are special constructions and are therefore relatively costly to produce. Valves produced in large series can be used for the pilot valve arrangement if, according to patent claim 15, the latter has a first pilot valve arranged between the first line segment and a relief line or connectable between these and a second pilot valve arranged between the load indication line and the relief line or connectable between these, and the response pressure of the second pilot valve is lower than the response pressure of the first pilot valve.

A refinement according to patent claim 16 is especially preferred in this case, according to which the two pilot valves are pressure limiting valves and the second pilot valve can be connected with its inlet to the first line segment via a reversing valve switchable as a function of the pressure occurring in a further line segment of the load indication line. Here, too, the reversing valve may be a small valve which is produced cost-effectively in large quantities.

In a construction according to the patent claim 17, the following is achieved. Since the inlet of the second pilot valve constructed as a pressure limiting valve is connected with its inlet, downstream of a nozzle, to a first further line segment of the load indication line or to the associated individual load indication duct, when the associated function (directional control valve section) is operating in the solo mode the system pressure is limited by the response pressure of the second pilot valve. By contrast, when this function (directional control valve section) is operating in the parallel mode, with a function arranged further forward and set at a higher pressure (directional control valve section), the pump pressure can rise to the higher value, since a higher control pressure can be indicated to the regulating valve via the load-sensing branch of the front function. In the event of the actuation of the function (directional control valve section) which is assigned to a line segment following the first further line segment to the rear, the reversing valve is switched and the pressure in the first line segment of the load indication line is thereby limited to the low response pressure of the second pilot valve, so that the system pressure is also limited to the low value.

According to patent claim 18, the second pilot valve is arranged between the first line segment and the relief line and its valve element can be acted upon in the closing direction by a valve spring and in the opening direction by the pressure occurring in the further line segment. No directional control valve is used here. In this construction, in the event of a parallel actuation of a plurality of hydraulic consumers, the system pressure can rise above the value induced by the response pressure of the second pilot valve, as long as the load pressure of the hydraulic consumer protected with the lower pressure lies below the response pressure of the second pilot valve. Only when the load pressure rises to the response pressure of the second pilot valve does the latter limit the control pressure of the regulating valve to a value lying below the response pressure by the amount of the regulating Δp.

Patent claims 19 to 21 relate to the advantageous accommodation of the pilot valve arrangement in a directional control valve section with a single-acting function, in which the free space of the consumer connection not required is available. The reversing valve is advantageously arranged perpendicularly to the plane of the directional control valve disk, since the control line for the pressure signal for adjusting the pilot valve arrangement, said control line running perpendicularly to the disk planes, can issue into the reversing valve directly at the flange face of the single-acting directional control valve control section.

Several exemplary embodiments of the hydraulic arrangement according to the invention are illustrated in the drawings as a circuit diagram and partially as a construction. The invention, then, is explained in more detail with reference to the figures of these drawings in which:

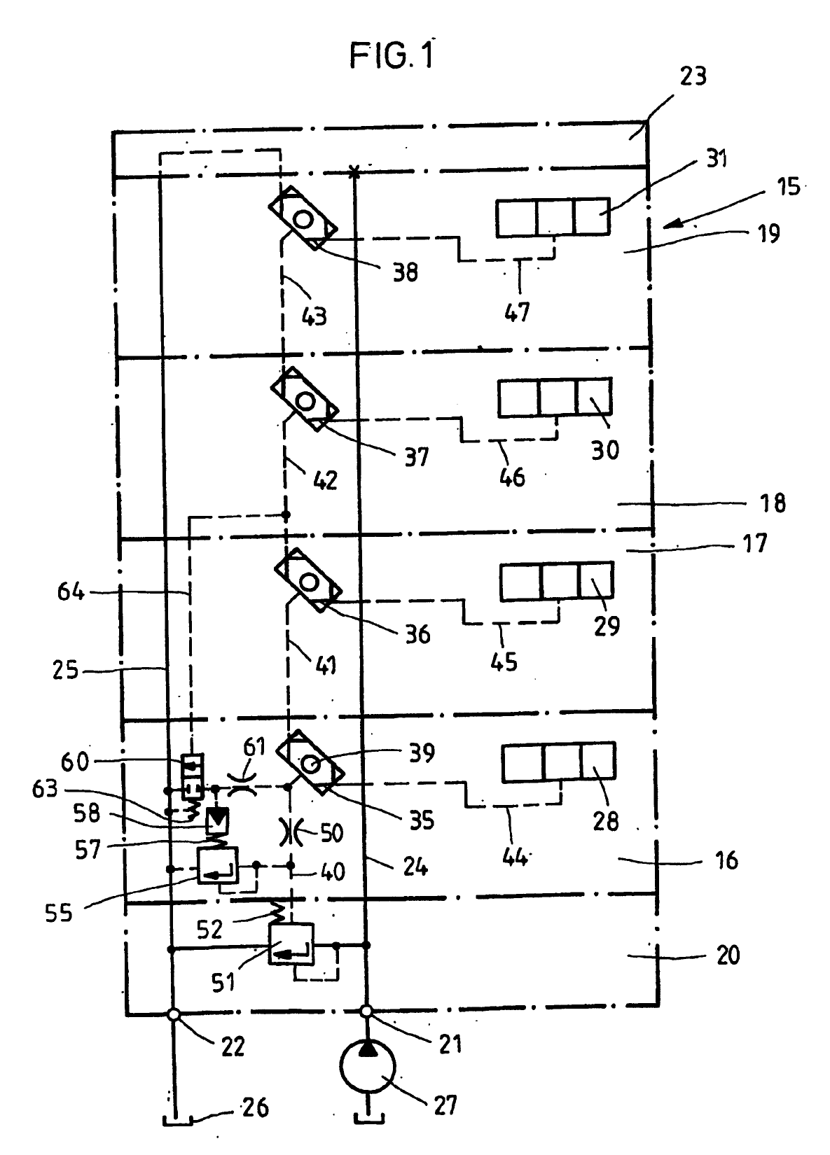

FIG. 1 shows a circuit diagram of first exemplary embodiment, in which the control pressure can be limited by a single pressure limiting valve to two values determined by a spring prestress of different intensity and in which adjustment takes place by the reversal of a 2/2-way directional control valve,

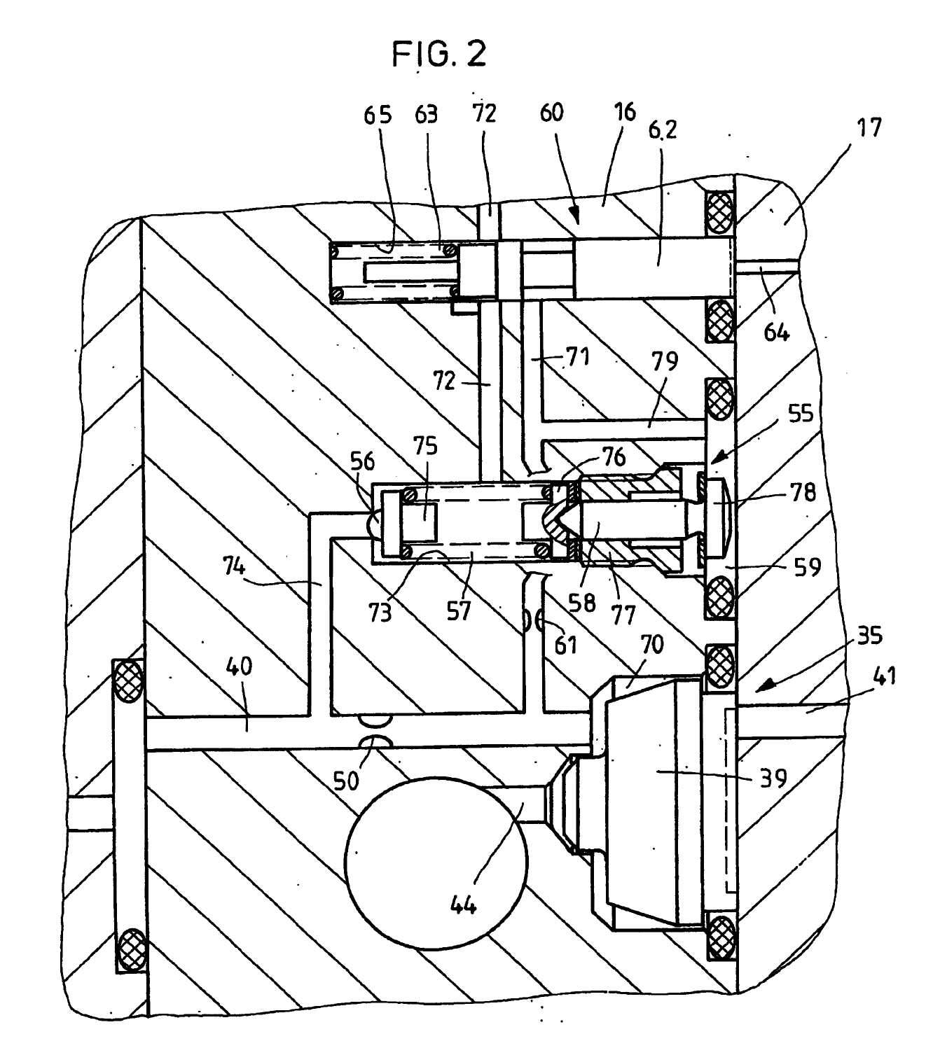

FIG. 2 shows a first arrangement and structural refinement of the pressure limiting valve and the 2/2-way directional control from FIG. 1 within a directional control valve disk,

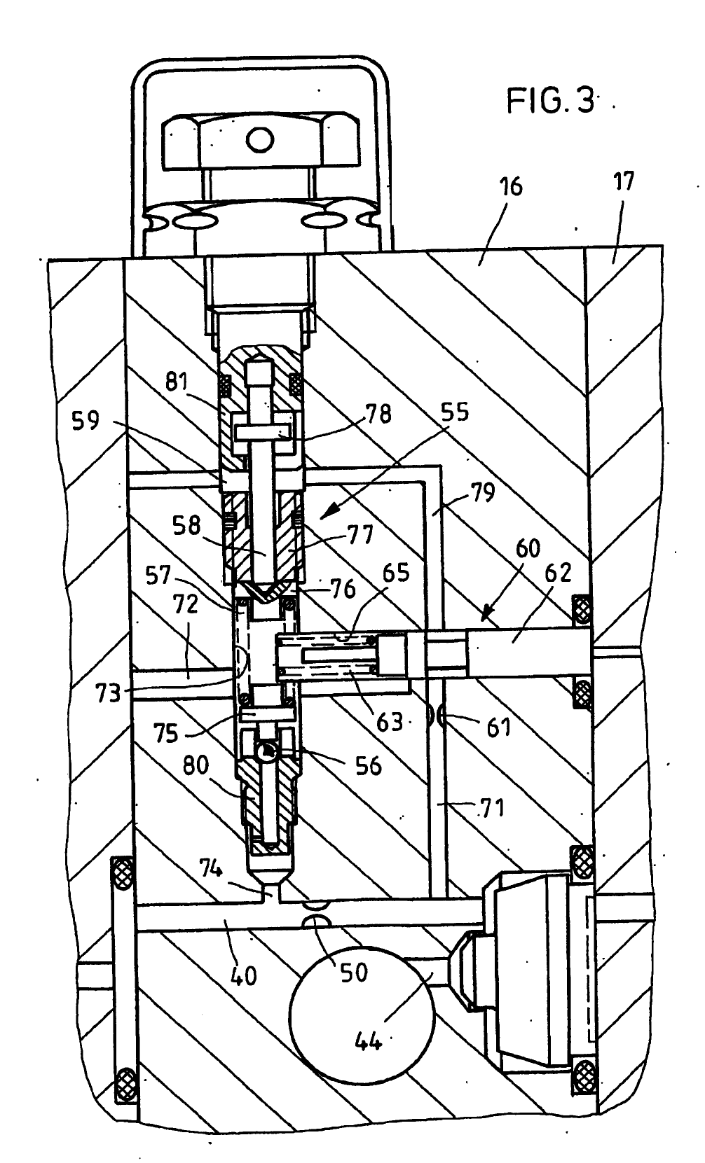

FIG. 3 shows a second arrangement and structural refinement of the pressure limiting valve and the 2/2-way directional control valve from FIG. 1 within a directional control valve disk,

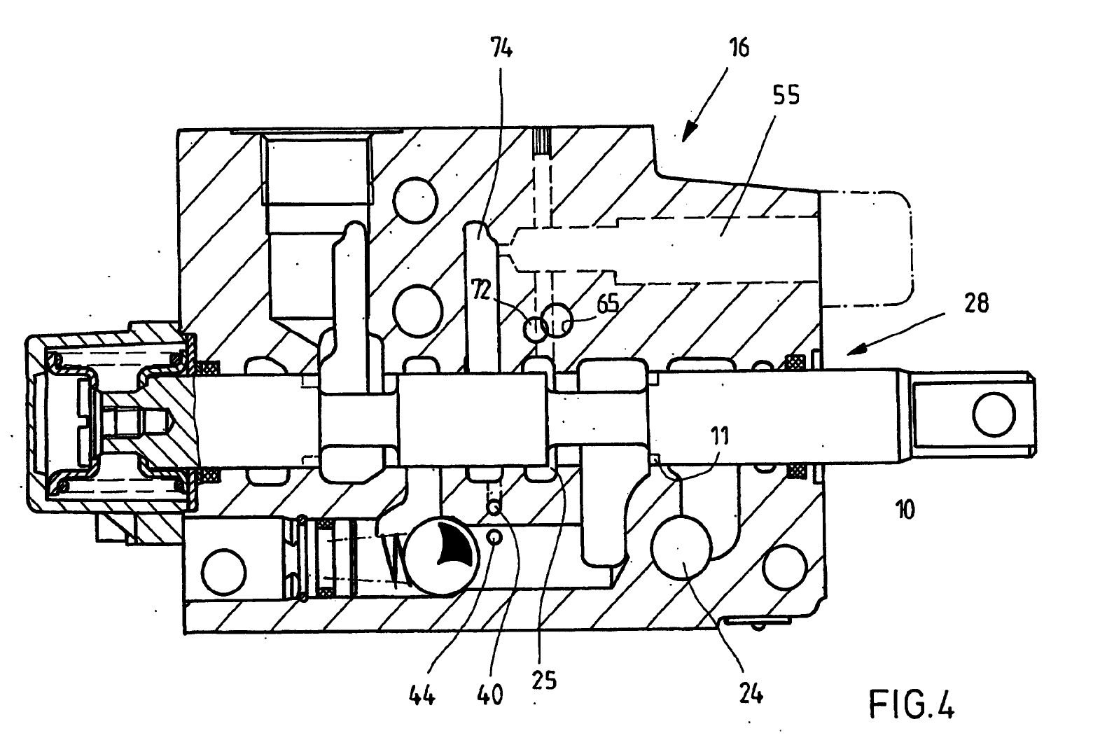

FIG. 4 shows diagrammatically a further arrangement of the pressure limiting valve from FIG. 3 in a section perpendicular to that from FIG. 3,

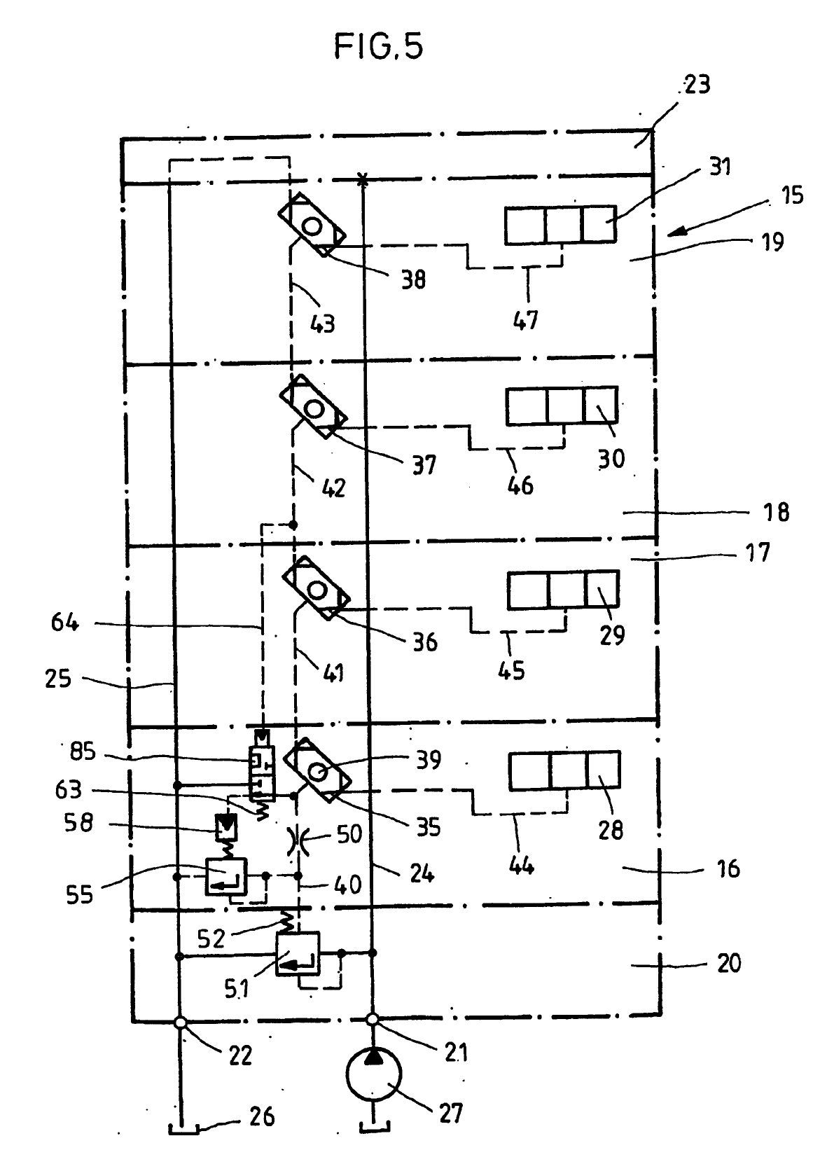

FIG. 5 shows a circuit diagram of the second exemplary embodiment, in which, as compared with the first exemplary embodiment, the 2/2-way directional control valve is replaced by a 3/2-way directional control valve,

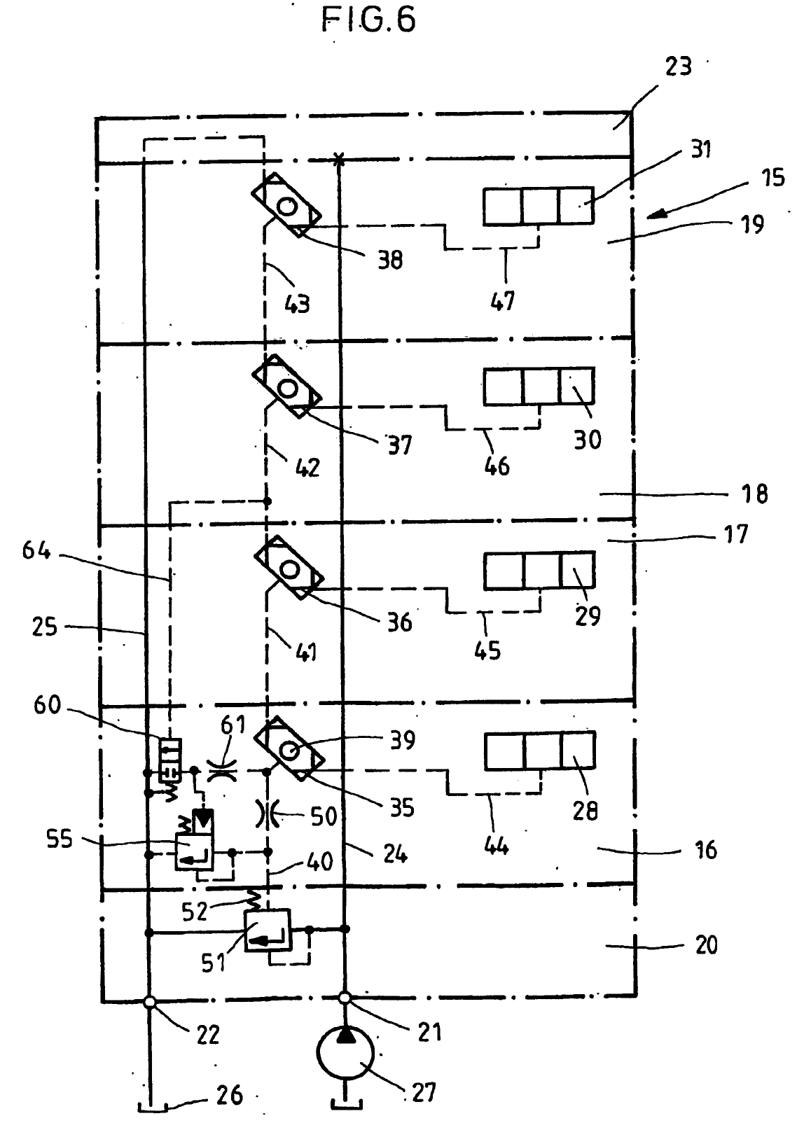

FIG. 6 shows a circuit diagram of the third exemplary embodiment, in which the control pressure can be limited by a single pressure limiting valve to two values determined by active pressure faces of different size and in which adjustment takes place by the reversal of a 2/2-way directional control valve,

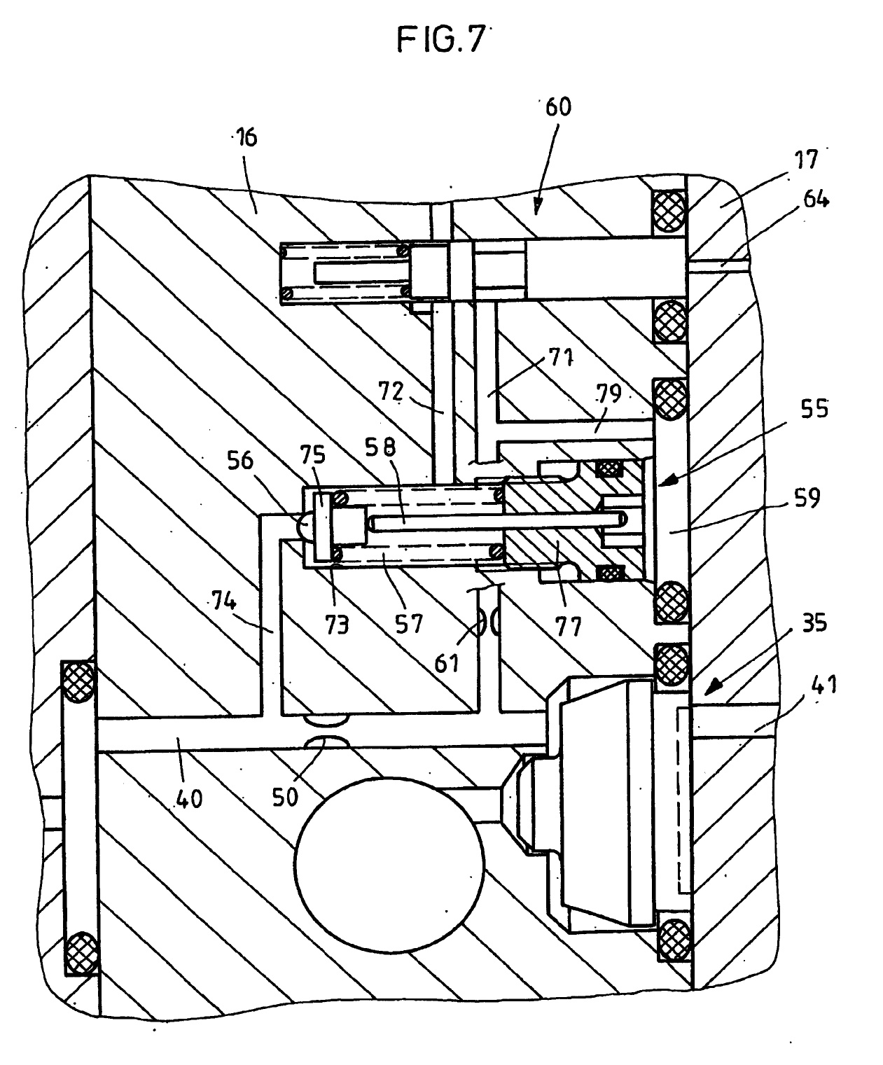

FIG. 7 shows the arrangement and structural refinement of the pressure limiting valve and the 2/2-way directional control valve from FIG. 6 within a directional control valve disk,

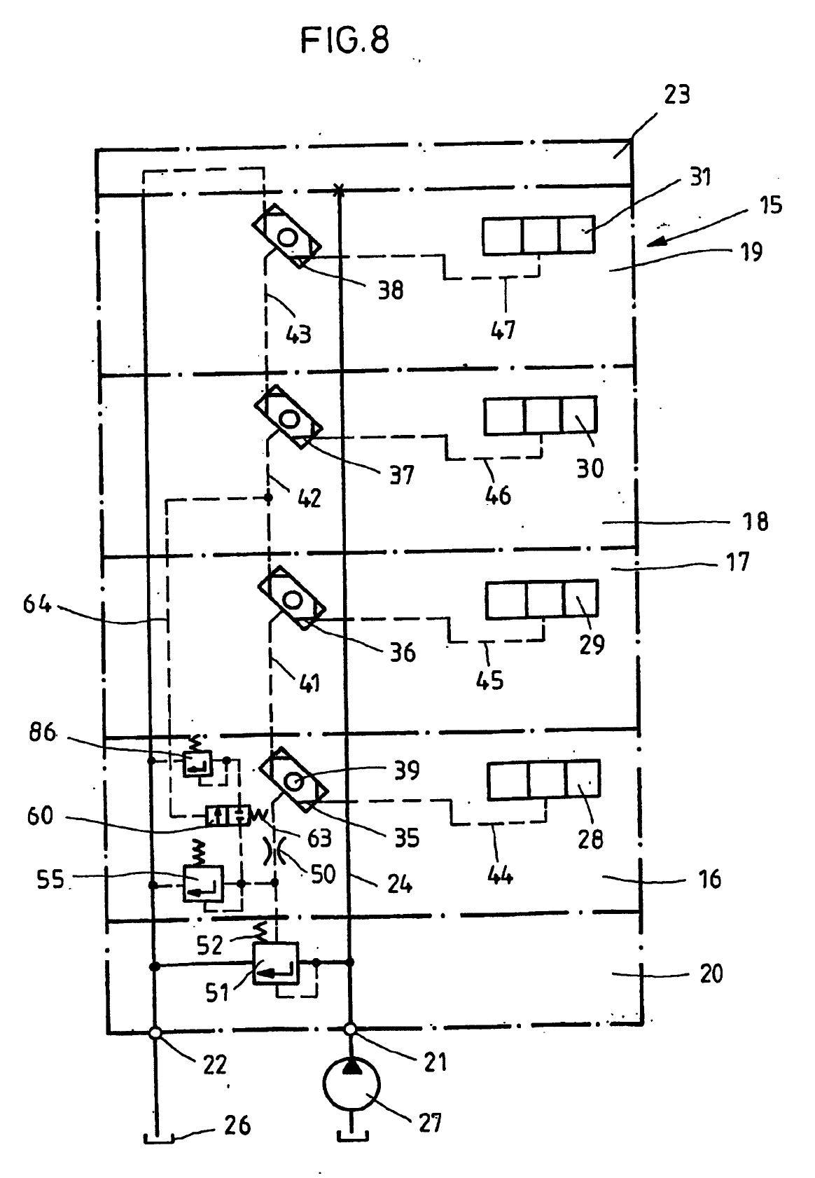

FIG. 8 shows a circuit diagram of the fourth exemplary embodiment which has two pressure limiting valves set at different response pressures and in which the pressure limiting valve having the lower response pressure can become active after the reversal of a 2/2-way directional control valve,

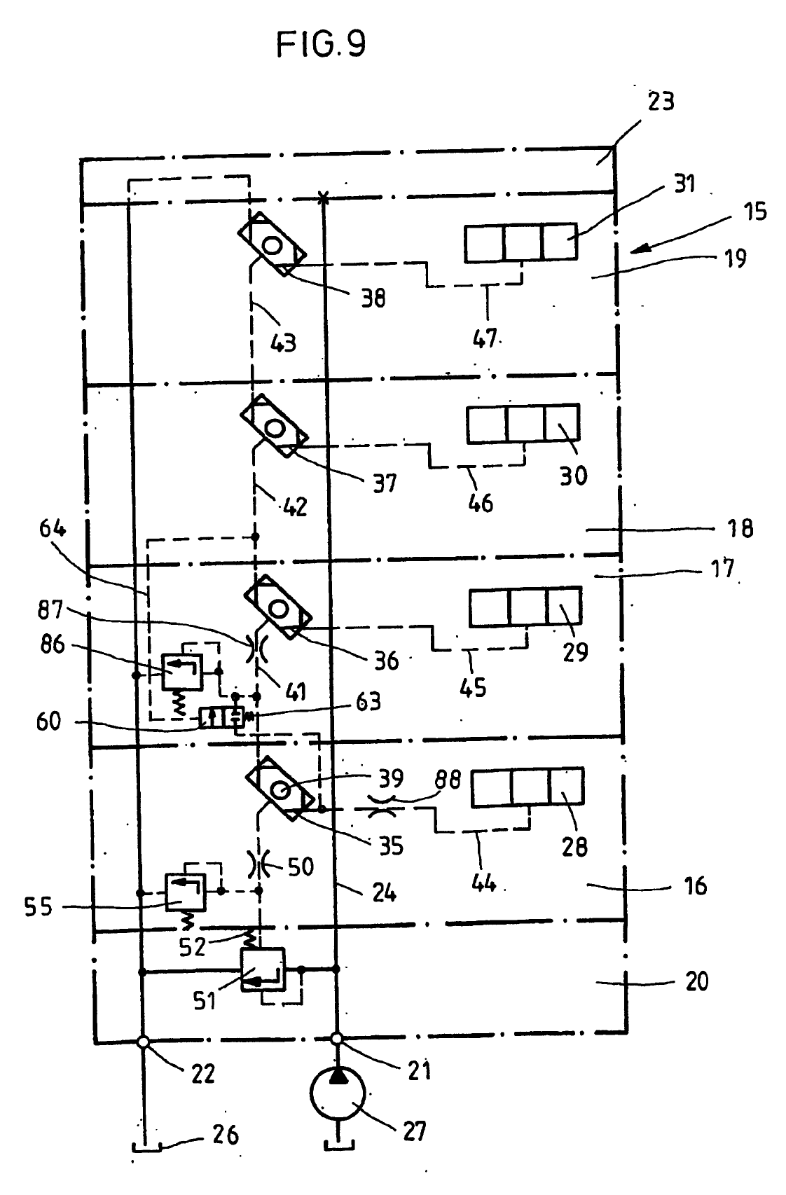

FIG. 9 shows a circuit diagram of the fifth exemplary embodiment which, like the fourth exemplary embodiment, has two pressure limiting valves and one 2/2-way directional control valve and in which the pressure limiting valve having the lower response pressure is connected, downstream of a nozzle, to the second line segment of the load indication time in the second directional control valve section and the 2/2-way directional control valve can connect the individual indication duct of the first directional control valve section to the second line segment,

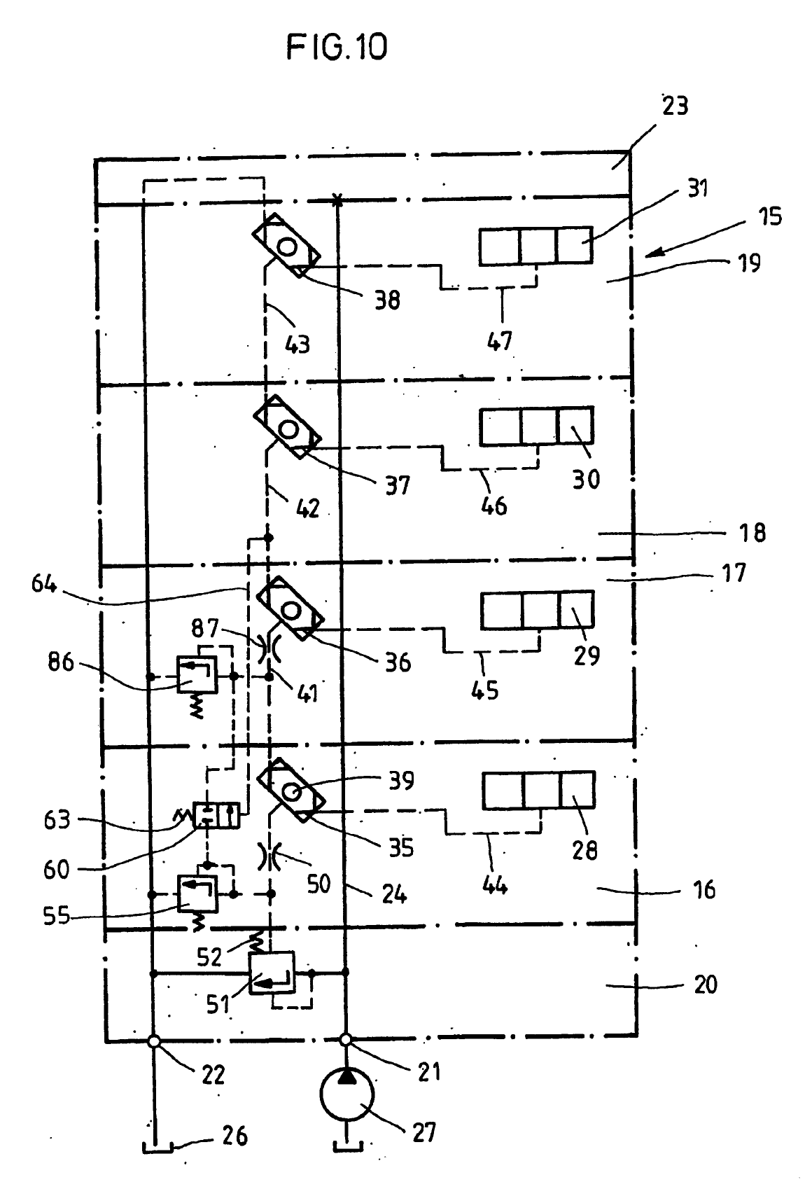

FIG. 10 shows a circuit diagram of the sixth exemplary embodiment in which, in contrast to the fifth exemplary embodiment, the 2/2-way directional control valve can connect the first line segment of the load indication line to the inlet of the pressure limiting valve having the lower response pressure,

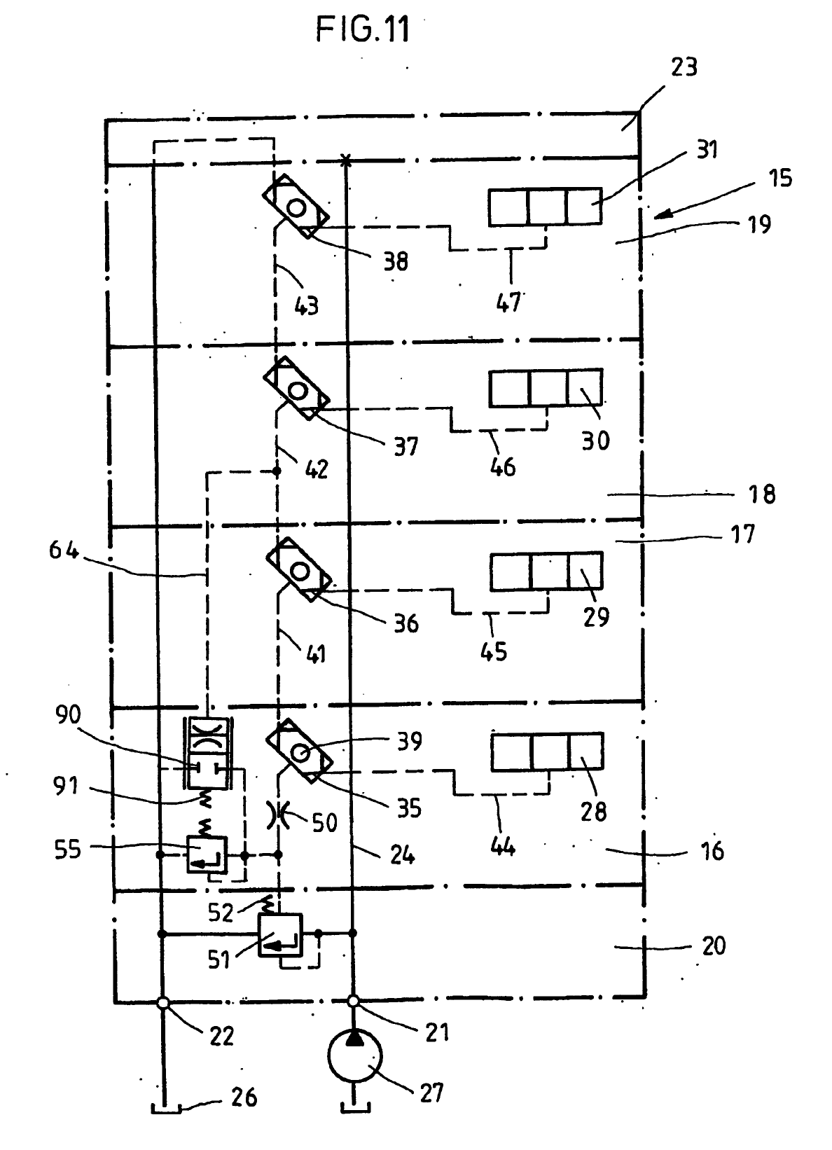

FIG. 11 shows a circuit diagram of the seventh exemplary embodiment in which a pressure limiting valve set at a high response pressure and a throttle valve controlled by the pressure in a further line segment of the load indication line are connected, between a nozzle and the regulating valve, to the first line segment of the load indication line,

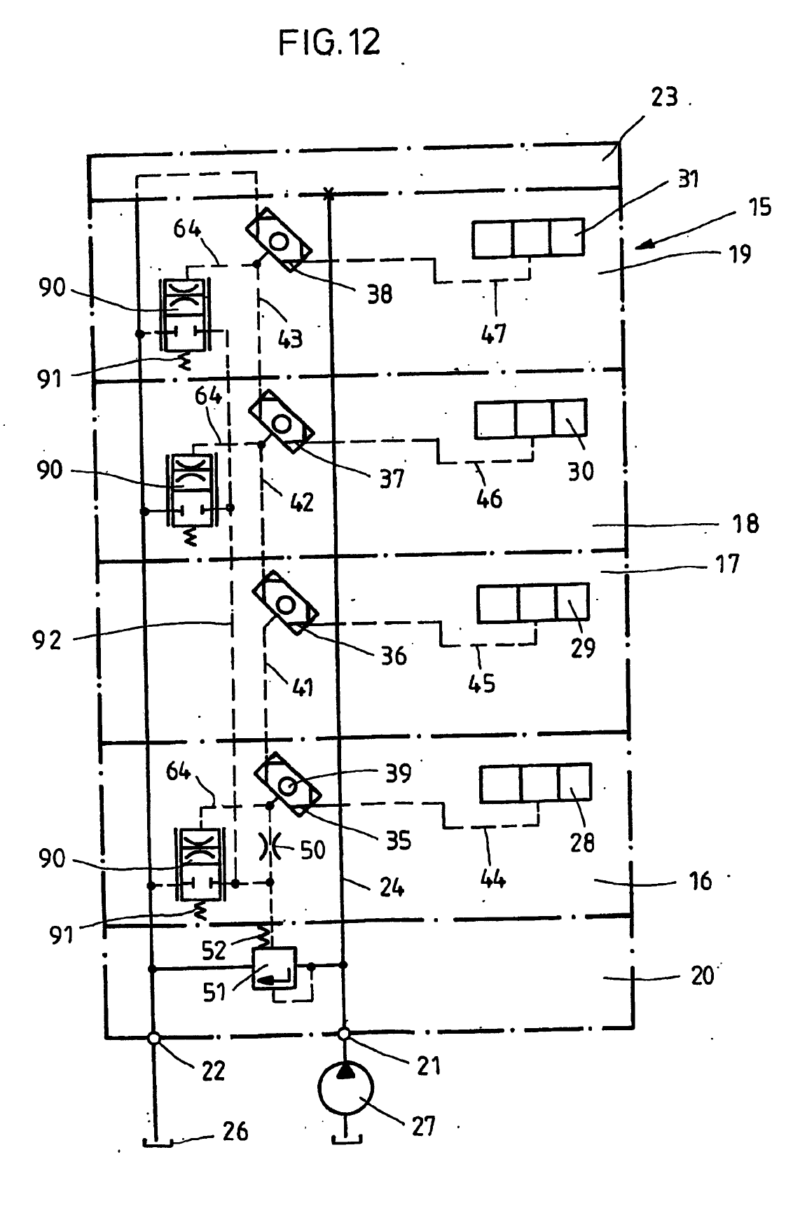

FIG. 12 shows a circuit diagram of the eighth exemplary embodiment, in which three throttle valves set at different response pressures are present, and

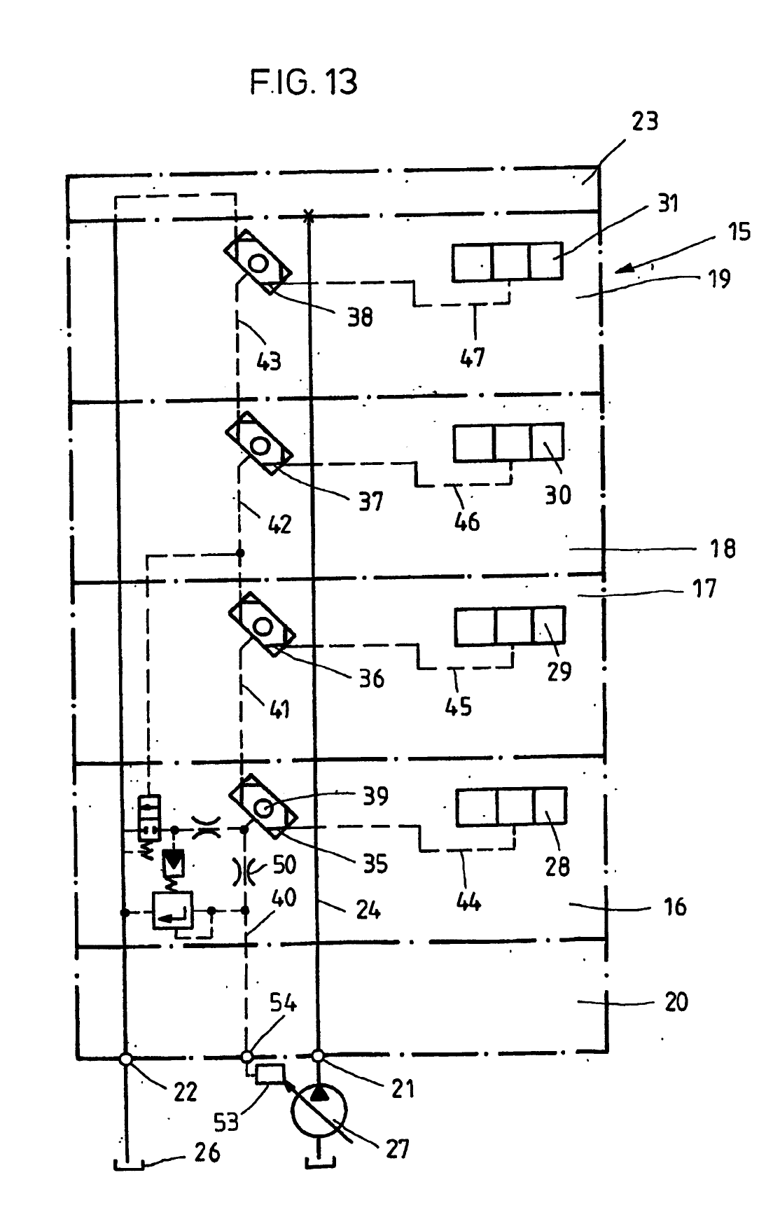

FIG. 13 shows a circuit diagram of an exemplary embodiment in which fixed displacement pump and bypass pressure compensator are replaced by a variable displacement pump having load-sensing regulation.

According to the circuit diagram shown, a control block 15, which is provided for a forklift truck, contains four directional control valve disks 16, 17, 18 and 19, an inlet disk 20, which has an inflow connection 21 and an outflow connection 22, and an end disk 23, by means of which an inflow duct 24 passing from the inflow connection 21 through the inlet disk and the directional control valve disks is closed. An outflow duct 25, which leads into the end disk, passes from the outflow connection 22 through the inlet disk and the directional control valve disks. Hydraulic oil can flow out from the outflow connection 22 to a tank 26. The inflow connection is connected to the pressure connection of a hydraulic pump 27 which can thus convey hydraulic oil sucked in from the tank into the inflow duct 24. According to their sequence starting from the inlet disk 20, let the directional control valve disk 16 be the first or foremost, the directional control valve disk 17 the second, the directional control valve disk 18 the third and the directional control valve disk 15 the last or rearmost. When components or ducts within a directional control valve disk are referred to below as the first, second, third or last, this is intended to point clearly to their association with the corresponding directional control valve disk.

Each directional control valve disk contains a proportionally adjustable directional control valve 28, 29, 30 and 31, by means of which a hydraulic consumer, a hydraulic cylinder in the case of a forklift truck, can be controlled in terms of the amount and direction of the speed. The directional control valve 28 of the first directional control valve disk 18 is assigned to the “lifting” function of the fork, for which a single-acting hydraulic cylinder is sufficient. The directional control valve 29 of the second directional control valve disk 17 is assigned to the “tilting” function of the lifting structure, and the directional control valves 30 and 31 of the directional control valve disks 18 and 19 are assigned two additional functions, such as “extension of the fork” and “sideways movement of the fork”. For these functions, the hydraulic consumers are double-acting hydraulic cylinders.

In addition to a directional control valve, a changeover valve 35, 36, 37, and 38 with a valve body 39 is located in each directional control valve disk. Depending on the pressure conditions, a changeover valve connects a load-sensing duct 40, 41, 42, and 43 of a directional control valve disk, said load-sensing duct emanating from the middle connection of the changeover valve, to an individual indication duct 44, 45, 46 and 47 of the directional control valve disk or to the load-sensing duct of the following directional control valve disk. One side connection of the changeover valve 38 of the last directional control valve disk is connected to the outflow duct 25 via the end disk 23. The individual indication duct of each directional control valve disk is, in turn, connected to the forward flow to the hydraulic consumer via the associated directional control valve in a working position of the directional control valve, so that the load pressure of the hydraulic consumer occurs in said indication duct which, in the neutral position of the directional control valve, is relieved of pressure toward the outflow line. A nozzle 50 is inserted into the first load-sensing duct 40.

In the exemplary embodiments according to the circuit diagrams of FIGS. 1, 5, 6 and 8 to 12, the hydraulic pump 27 is a fixed displacement pump. The load-sensing regulator is formed by a pressure compensator 51 which is accommodated in the inlet disk 20 and which lies between the inflow duct 24 and the outflow duct 25. A regulating piston of the pressure compensator is acted upon in the opening direction by the pump pressure in the inflow duct 24. The regulating piston of the pressure compensator has acting on it in the closing direction a compression spring 52 and a control pressure which occurs in the load-sensing duct 40, downstream of the nozzle 50, on the side remote from the changeover valve 35. The two faces on which the control pressure and the pump pressure act are of equal size. The regulating piston is thus force-free when the pump pressure is higher than the control pressure by the amount of the pressure equivalent of the compression spring 52. This pressure difference is also designated as the regulating Δp and conventionally has a value between 5 bar and 20 bar.

In the exemplary embodiment according to FIG. 13, a hydraulic pump 27 is a variable displacement pump with a load-sensing regulating valve 53, indicated diagrammatically, the regulating piston of which is acted upon, downstream of the nozzle 50, by the control pressure with the effect of an adjustment of the hydraulic pump in the direction of a larger stroke volume and is acted upon by the pump pressure by a regulating spring and in the direction of a smaller stroke volume. Here, too, a pump pressure is set which lies above the control pressure downstream of the nozzle 50 by the amount of the regulating Δp corresponding to the pressure equivalent to the regulating spring. The use of a variable displacement pump with load-sensing regulation entails fewer losses of nonutilizable energy, since not only the pump pressure, but also the pump conveying quantity is limited to the necessary amount. In the exemplary embodiment according to FIG. 13, the load-sensing duct 40 is continued in the inlet disk 20 and is connected via a load-sensing connection 54 and a line to the regulating valve 53 built onto the hydraulic pump 57.

In the exemplary embodiments according to FIGS. 1 to 4, 5, 6, 8 to 11 and 13, within the directional control valve disk 16 a directly controlled pressure limiting valve 55 is arranged, the inlet of which is connected to that part of the load-sensing duct 40 lying downstream of the nozzle 50 and the outlet of which is connected to the outflow duct 25. Directly controlled pressure limiting valve means that the moveable valve element 56, which can be seen from FIGS. 2 and 3, is acted upon in the opening direction, at an effective active face, by the pressure of the inlet of the valve and in the closing direction by a valve spring 57. The pressure limiting valve 55 allows the pressure at its inlet to rise only up to a limit pressure which generates at the active face a pressure force which is equal to the spring force.

In the exemplary embodiments according to FIGS. 1 to 4 and 5, the spring force can be varied between two values determined by two abutments for one end of the valve spring 57. For this purpose, that end of the valve spring 57 which is remote from the valve element 56 can be displaced by means of an auxiliary piston 58 in the direction of the valve seat, on which the valve element 56 sits in the closed state of the valve 55. The auxiliary piston is contiguous with an active face to a control space 59, the reaction of pressure upon which depends on the switching position of a directional control valve reversible between two switching positions and likewise installed in the directional control valve disk 18. In the exemplary embodiments according to FIGS. 1 to 4, this directional control valve is a directional control valve 60 with two connections, that is to say a 2/2-way directional control valve which is arranged in series with a nozzle 61 and, downstream of the latter, between the load-sensing duct 40 upstream of the nozzle 50 and the outflow duct 25. Thus, when the directional control valve 60 blocks, the auxiliary piston 58 is acted upon by the pressure occurring upstream of the nozzle 50 in the load-sensing duct and highly distresses the valve spring, so that the limit pressure is high. When the directional control valve is open, the auxiliary piston is relieved of pressure. The valve spring 57 is prestressed to a lesser extent and the limit pressure is lower.

A valve piston 62 of the directional control valve 60 is loaded in a closing direction by a compression spring 63 and can be acted upon in the opening direction, via a control line 64 leading through the directional control valve disks 17, by the pressure occurring in the third load-sensing duct 42. In this case, the force of the compression spring 63 may be selected such that the directional valve opens even at a very load pressure of, for example, 10 bar. However, the compression spring may also be set at a higher pressure which, however, is in any event so low that, with the directional control valve 30 actuated, the pressure limiting valve 55 is set at a low limit pressure before the higher limit pressure is reached.

For the description of the functioning of the control arrangement according to FIG. 1, let it be assumed, for example, that the high limit value for the control pressure lies around 120 bar and the low limit pressure around 60 bar. Let the regulating Δp be 10 bar. When one of the “lifting” or “tilting” functions is actuated alone or parallel to the other, the highest load pressure of the actuated functions occurs, upstream of the nozzle 50, in the load-sensing duct 40. The two further directional control valves 30 and 31 are not actuated, so that the control line 64 is relieved of pressure and the directional control valve 60 assumes the switching position shown in FIGS. 1 to 3. The auxiliary piston 58 is acted upon by the highest load pressure and has highly prestressed valve spring 57. The pressure limiting valve 55 limits the control pressure downstream of the nozzle 50 to 120 bar, so that the pump pressure and consequently the load pressure of the hydraulic consumers rise to at most 130 bar for the “lifting” and “tilting” functions.

When one of the directional control valves 30 or 31 is actuated, pressure occurs in the third load-sensing duct 42. When the directional control valve 60 is reversed, for example even at a pressure of 10 bar in the control line 64, then, as soon as this load pressure occurs at one of the consumers controlled by means of the directional control valves 30 and 31, the pressure limiting valve is set at the low limit pressure of 60 bar. The pump pressure can then rise to at most 70 bar. The lower pressure at the third or fourth consumer cannot become higher. If the first or second consumer is activated simultaneously, this moves only when its load pressure is lower than 70 bar.

However, the load pressure of the third or fourth consumer is limited to 70 bar even when the directional valve 60 is reversed only at 70 bar. This has the effect that, when the third or fourth consumer and the first or second consumer are actuated simultaneously, the pump pressure can rise to above 70 bar when the load pressure of the third or fourth consumer is lower than 70 bar. The pump pressure is then throttled, via the metering diaphragm in the directional control valve 30 or 31, to the load pressure of the third or fourth hydraulic consumer. Finally, when this consumer comes up against an abutment, its load pressure rises to 70 bar, so that the directional control valve 60 is reversed and the pressure limiting valve 55 is adjusted to the low limit pressure of 60 bar. The pump pressure falls to 70 bar, so that, even with the directional control valve 30 or 31 open and without an oil flow, the load pressure of the third or fourth hydraulic consumer remains limited to 70 bar.

According to FIG. 2, the valve body 39 of the changeover valve 35 is located in a recess 70 in the flange face of the directional control valve disk 16, said flange face bearing against the directional control valve disk 17. The load-sensing duct 40 of the directional control disk 16, in which duct the nozzle 50 is located, and the load-sensing duct 41 of the directional control valve disk 17 issue, in alignment with one another, eccentrically into the recess 70. Moreover, the individual indication duct 44 of the directional control valve disk 16 issues into the recess. Depending on the duct in which the higher pressure occurs, the valve body 39 assumes a position such that the load-sensing duct 41 or the indication duct 44 is connected to the load-sensing duct 40.

The two valves 55 and 60 are installed in a directional control valve disk 16 perpendicularly to the plane of the directional control valve disk 16 from the flange face bearing against the directional control valve disk 17. Between the valve piston 62 of the directional control valve 60 and the bottom of a blind bore 65 is clamped the compression spring 63. The latter seeks to keep the valve piston in bearing contact against the directional control valve disk 17. The blind bore 65 has issuing into it a transverse duct 71 which emanates from the load-sensing duct 40 upstream of the nozzle 50 and in which the nozzle 61 is located. Moreover, the blind bore 65 is intersected by a duct 72 which is connected to the outflow duct 25. The space in which the compression spring 63 is located is also relieved of pressure. The control duct 64 running in the directional control valve disk 17 issues axially into the blind bore 65.

The valve piston 62 assumes, under the influence of the compression spring 63, a rest position in which said valve piston is pressed against the directional control valve disk 17. In this rest position, the two ducts 71 and 72 are sealed off relative to one another. When the pressure force generated by the pressure in the control duct 64 at the cross-sectional face of the valve piston 62 overshoots the spring force, the valve piston is displaced up to abutment against the bottom of the blind bore 65 into its second switching position in which that part of the duct 71 which lies downstream of the nozzle 61 is connected to the duct 72 and consequently relieved of pressure.

The individual parts of the pressure limiting valve 55 are located in a blind bore 73, into which a duct 74 connected downstream of the nozzle 50 to the load-sensing duct 40 issues centrally at the bottom. The issue margin of the duct 74 forms a seat for the valve element 56, constructed as a ball, of the pressure limiting valve. The ball is held in a spring plate 75 of the valve spring 57 which can be supported via a further spring plate 76 on a screwable insert 77 screwed up to abutment into the blind bore 73. The distance between the two spring plates when one is supported on the seat via the ball 56 and the other is supported on the screwable insert determines a low prestress of the valve spring 57. This prestress may be adjusted by means of washers between the screwable insert 77 and the spring plate 76. The space in which the valve spring 57 is located is connected to the outflow duct 25 via the duct 72 and is thus relieved of pressure. The auxiliary piston 58 is sealingly guided slideably in a central axial bore of the screwable insert. The auxiliary piston is located with a stop collar 78 in the control space 59 which is formed behind the screwable insert 77 in the directional control valve disk 16 and which is connected to the duct 71, downstream of the nozzle 61, via a duct 79. The guide cross section with which the auxiliary piston 58 is guided in the screwable insert 77 and which is equal to the active face for the pressure which occurs in the control space 59 and which is to act upon the auxiliary piston in the direction of the valve element 56 is larger than the seat cross section for the valve element 56, so that, in the event of a closing of the directional control valve 60, the auxiliary piston 58 will first prestress the valve spring 57 to a greater extent until the stop collar 78 comes to bear against the screwable insert 77, before, with the pressure rising further in the load-sensing duct 40, the pressure limiting valve opens. The higher prestress of the valve spring 57 may be adjusted by means of washers on the stop collar 78.

In the configuration according to FIGS. 3 and 4, the directional control valve 60 is constructed in exactly the same way as in FIG. 2 and in exactly the same way as there is arranged in the directional control valve disk 16 perpendicularly to the disk plane of the latter in a blind bore 65. By contrast, the individual parts of the pressure limiting valve 55 are located in a blind bore 73, the axis of which runs parallel to the disk plane and perpendicularly (FIG. 3) or parallel to the axis of the valve bore which receives the control slide 10 of the directional control valve 28. The construction of the metering diaphragm by means of control grooves 11 can be seen on said control slide. An especially large amount of space for accommodating the valves 55 and 60 is available in the directional control valve disk 16 because this disk is provided for actuating a single-acting hydraulic cylinder and therefore has only one consumer connection.

The pressure limiting valve according to FIG. 3, which projects, parallel to one consumer connection, out of the directional control valve disk, has a screwed-in valve seat 80 for the valve element 56, again constructed as a ball. The valve spring 57 is supported on the ball 56 via the spring plate 75. The valve spring 57 can be supported via the spring plate 76 on the screwable insert 77 which in this case is provided with a radial sealing ring and which can be rotated in order to set the low prestress of the valve spring. Rotation is possible, however, only when the further screwable insert 81 provided with a radial sealing ring is not located in the bore 73. The auxiliary piston 58 is suspended with its stop collar 78 on the screwable insert 81. Thus, by the screwable insert 81 being rotated, the high prestress of the valve spring 57 can be set. This is possible from outside. The screwable insert 81 may be secured by means of a lock nut and be lead-sealed with a protective cap.

By the pressure limiting valve 55 being arranged differently from the FIG. 2, the ducts run differently in FIG. 3 than in FIG. 2. There is, however, no difference in terms of circuitry. Upstream of the nozzle 50 in the load-sensing duct 40, the duct 71 branches off, which leads to the directional control valve 60 and in which the nozzle 61 is located. Connected downstream of the nozzle 61 to the duct 71, the duct 79 runs to the control space 59 between the two screwable inserts 77 and 81 of the pressure limiting valve 55. The spring space of this valve is, in turn, connected to the relief duct 72.

In the exemplary embodiment according to FIG. 5, the same pressure limiting valve 55 is used as in the exemplary embodiment according to FIG. 1. However, the 2/2-way directional control valve 60 and the nozzle 61 from FIG. 1 are replaced by a 3/2-way directional control valve 85 which, in one switching position, which it assumes under the action of a spring 63, connects the control space on the auxiliary piston 58, upstream of the nozzle 50, to the load-sensing duct 40 and, in its other switching position, into which it is brought by the pressure in the control line 64, relieves the control space toward the outflow line 25. There is no control-oil loss stream here when the auxiliary piston is relieved. The functioning of the exemplary embodiment according to FIG. 5 is otherwise identical to that of the exemplary embodiment from FIG. 1.

The exemplary embodiment according to FIGS. 6 and 7, like the exemplary embodiment according to FIG. 1, uses the 2/2-way directional control valve 60 and the nozzle 61 in order to control the adjustment of a pressure limiting valve 55 which again is connected with its inlet, downstream of the nozzle 50, to the load-sensing duct 40 and with its outlet to the outflow duct 25. As in the refinement according to FIG. 2, the individual parts of the pressure limiting valve 55 according to FIGS. 6 and 7 are accommodated in a blind bore 73, into which the duct 74 issues centrally at the bottom. The issue margin of the duct 74 again forms the seat for the valve element 56 constructed as a ball. The ball is held in the spring plate 75 for the valve spring 57 which, furthermore, is in this case supported directly on the screwable insert 77 screwed into the blind bore 73. The screwable insert 77 is provided with a radial sealing ring, with the aid of which the control space 59 is sealed off relative to the pressure-relieved spring space. By the screwable insert 77 being rotated, the prestress of the valve spring 57 can be adjusted.

In the exemplary embodiment according to FIGS. 6 and 7, the pressure limiting valve 55 is not adjusted between two different response pressures by a variation in the spring prestress, but by a variation in the effective active face for the pressure acting upon the valve element. For this purpose, once again, an auxiliary piston 58 is sealingly guided slideably in a central axial bore of the screwable insert 77 and is acted upon, at an active face corresponding to its guide cross section, by the pressure occurring in the control space 59. In contrast to the exemplary embodiments according to FIGS. 1 to 4, in this case the auxiliary piston 58 does not lift off one end of the valve spring 57 from the screwable insert 77, but acts directly on the valve element 56 in the closing direction via the spring plate 75. The guide cross section with which the auxiliary piston 58 is guided in the screwable insert 77 is smaller than the seat cross section for the valve element 56.

For the description of the functioning of the control arrangement according to FIGS. 6 and 7, let it be assumed, once again, that the regulating Δp amounts to 10 bar. When one of the directional control valves 30 or 31 is actuated, pressure occurs in the third load-sensing duct 42. If the directional control valve 60 is reversed, for example, even at a pressure of 10 bar in the control line 64, then, as soon as this load pressure occurs at one of the consumers controlled by means of the directional control valves 30 and 31, the control space 59 and consequently also the auxiliary piston 58 are relieved of pressure. The auxiliary piston therefore exerts no force on the valve element 56. The pressure downstream of the nozzle 50 in the load-sensing duct 40, which, as long as the pressure limiting valve 55 is closed, is equal to the pressure upstream of the nozzle 50, acts upon the valve element 56 at an active face corresponding to the seat cross section and opens the pressure limiting valve at a low limit pressure of, for example, 60 bar. The pump pressure can then rise to at most 70 bar. The load pressure at the third or fourth consumer cannot become higher.

When one of the “lifting” or “tilting” functions is actuated alone or parallel to the other, the highest load pressure of the actuated functions occurs, upstream of the nozzle 50, in the load-sensing duct 40. The two further directional control valves 30 and 31 are not actuated, so that the control line 64 is relieved of pressure and the directional control valve 60 assumes the switching position shown in FIGS. 6 and 7. The auxiliary piston 58 is acted upon by the highest load pressure which presses the auxiliary piston, with the force generated at its active face, in the closing direction against the valve element 56. As long as the pressure limiting valve 55 is closed, the pressures upstream and downstream of the nozzle 50 are equal. The pressure limiting valve thus begins to open when the pressure acting at an effective active face, which is equal to the differential face between the seat cross section for the valve element 56 and the guide cross section of the auxiliary piston 58, generates a force which is as high as the force of the valve spring 57. The oil stream flowing via the nozzle 50 after the start of the opening generates a pressure difference across the nozzle 50, so that, after the opening of the pressure limiting valve, the pressure in the control space 59 acting upon the auxiliary piston 58 is higher than the pressure in the duct 74. In the static state, the pressure difference is equal to the regulating Δp. In the static state, therefore, the valve element is acted upon in the opening direction by a pressure force derived from the pressure downstream of the nozzle 50 and from the seat cross section and in the closing direction by the force of the spring 57, said force determining the low limit pressure, and a pressure force which derives from the pressure in the control space 59, increased by the amount of the regulating Δp, as compared with the pressure in the duct 74, and from the guide cross section of the auxiliary piston 58. If, for example, the ratio between the guide cross section and the seat cross section is 1/2, then, with a regulating Δp of 10 bar and a lower limit pressure of 60 bar, the upper limit pressure amounts to 140 bar. With a face ratio of 1/3, the upper limit pressure amounts to 95 bar.

The exemplary embodiment according to FIG. 8 has, in addition to a simple pressure limiting valve 55 which is set at a high limit pressure and is permanently connected with its inlet, downstream of the nozzle 50, to the load-sensing duct 40, a second simple pressure limiting valve 86 which is set at a low limit pressure. Between the inlet of this second pressure limiting valve 86 and the load-sensing duct, downstream of the nozzle 50, is arranged a 2/2-way directional control valve 60 which is acted upon in the closing direction by a compression spring 63 and in the opening direction, via the control line 64, by the pressure occurring in the third load-sensing duct 42. When the directional control valve 60 is closed, the pressure limiting valve 86 is not active. The maximum control pressure for the pressure compensator 51 and consequently the maximum inflow pressure are determined by the pressure limiting valve 55. When the directional control valve is opened by the pressure in the load-sensing duct 42, the pressure limiting valve 86 determines the maximum control pressure for the pressure compensator 51 and consequently the maximum inflow pressure.

In the two exemplary embodiments according to FIGS. 9 and 10, as in the exemplary embodiment according to FIG. 8, there is a simple pressure limiting valve 55 which is set to a high response pressure and which is connected, downstream of the nozzle 50, to the load-sensing duct 40. The inlet to the second pressure limiting valve 86 set to low response pressure is in this case permanently connected to the second load-sensing duct 41 downstream of a nozzle 87 located in the load-sensing duct 41.

This means, in the first place, that the pressure limiting valve 55, when the first directional control valve 28 is actuated alone, and the pressure limiting valve 86, when the directional control valves 29, 30 and 31 are actuated alone or in parallel, determine the maximum control pressure for the pressure compensator 51.

In both exemplary embodiments, there is also a 2/2-way directional control valve 60 which blocks in a switching position brought about by the spring 63 and can be brought into an open switching position by a pressure occurring in the third load-sensing duct 42. In the exemplary embodiment according to FIG. 9, the directional control valve 60, in the open switching position, connects the individual indication duct 44 of the directional control valve disk 16, downstream of a nozzle 88, to the inlet of the pressure limiting valve 86 and, in the exemplary embodiment according to FIG. 10, connects the load-sensing duct 40, downstream of the nozzle 50, to said inlet of the pressure limiting valve 86. What is achieved thereby is that, when the directional control valve 30 or 31 is actuated, even with the simultaneous actuation of the directional control valve 28, the pressure limiting valve 86 set at the low limit pressure determines the maximum control pressure of the pressure compensator 51. If, by contrast, only the directional control valves 28 and 29 are actuated simultaneously, the pressure limiting valve 55 having the higher limit pressure determines the maximum control pressure for the pressure compensator 51, since the directional control valve 60 remains in its blocking position.

In the exemplary embodiment according to FIG. 11, the high maximum control pressure for the pressure compensator 51 is determined by a simple pressure limiting valve 55 in the same way as in the exemplary embodiments according to FIGS. 9 and 10. Furthermore, there is a throttle valve 90, the inlet of which is connected, downstream of the nozzle 50, to the load-sensing duct 40 and the outlet of which is connected to the outflow duct 25. The throttle valve 90 assumes a blocking position under the action of the compression spring 91 and can be adjusted proportionally, that is to say opened to a different extent, counter to the force of the spring, by a pressure occurring from the third load-sensing duct 42 via the control line 64. The spring constant is low for this purpose. The pressure at which the valve 90 responds is equal to the low maximum permitted load pressure of the hydraulic consumers controlled by the directional control valves 30 and 31.

To explain the functioning, let it be assumed that the throttle valve responds, for example, at a pressure of 60 bar. If, in the event of an actuation of one or both directional control valves 30 or 31 without an actuation of a directional control valve 28 or 29, a load pressure of 60 bar is reached, the throttle valve 90 opens a throttle cross section from the control side of the pressure compensator 51 to the outflow duct 25 and keeps the pressure on the control side below the load pressure of 60 bar by the amount of the regulating Δp, that is to say at 50 bar in the case of a regulating Δp of 10 bar.

Let the tilting or lifting function, that is to say the directional valve 28 or 29, be actuated, the load pressure of this function being higher than 60 bar, for example 100 bar. 60 bar then no longer occurs, upstream of the nozzle 50, in the load-sensing duct 40, but, instead, 100 bar. With the position of the throttle valve 90 being unchanged, the pressure downstream of the nozzle 50 and consequently on the control side of the pressure compensator 51 would therefore also rise. This would result in an increase in the inflow pressure and an increase in the load pressure at the hydraulic consumer which is controlled by means of the directional control valve 30 or 31 and which, for example, stands at an abutment. However, even an insignificant change of pressure in the load-sensing duct 42 leads to an enlargement of the throttle cross section of the valve 90, so that a pressure rise on the control side of the pressure compensator 51 occurs only within the framework of the opening characteristic of the valve 90. Even in the event of a parallel actuation of a directional control valve 30 or 31 and of a directional control valve 28 or 29, the maximum load pressure for the third and the fourth hydraulic consumer is therefore limited to the low value.

In the exemplary embodiment according to FIG. 11, the high maximum inflow pressure is set by means of a pressure limiting valve and a low maximum inflow pressure is set by means of a throttle valve. Both valves are accommodated in the directional control valve disk 16.

By contrast, in the exemplary embodiment according to FIG. 12, only throttle valves are used for setting the pressure levels. Here, a high pressure level is provided for the two hydraulic consumers controlled by means of the directional control valves 28 and 29, a medium pressure level is provided for the hydraulic consumer controlled by means of the directional control valve 30 and a load pressure level is provided for the hydraulic consumer controlled by means of the directional control valve 31. There are correspondingly three throttle valves 90, of which that set to the high response pressure is accommodated in the directional control valve disk 16, that set at the medium response pressure is accommodated in the directional control valve disk 18 and that set at the low response pressure is accommodated in the directional control valve disk 19. The inlets of the throttle valves are connected, downstream of the nozzle 50, to the load-sensing duct 40 via a line 92 leading through the directional control valve disks. A control line 64 for the throttle valve in the directional control valve disk 16 is connected, upstream of the nozzle 50, to the load-sensing duct 40, the control line 64 for the throttle valve in the directional control valve disk 18 is connected to the load-sensing duct 42 of the latter and the control line 64 for the throttle valve in the directional control valve disk 19 is connected to the load-sensing duct 43 of this.

When the directional control valve 31 is actuated, the throttle valve 90 of the directional control valve disk 19 keeps the pressure on the control side of the pressure compensator 51, in the same way as described with regard to FIG. 11, at a value such that the pressure in the load-sensing duct 43, which is equal to the load pressure of the corresponding hydraulic consumer, does not overshoot the low response pressure of the valve. The load pressure is therefore limited to the low value. The other two throttle valves operate likewise at the medium and the high pressure level.

1-21. (canceled)

22. A hydraulic control arrangement using load-sensing technology, with a first directional control valve (28, 29), via which pressure medium can be supplied to a first hydraulic consumer, and with at least one further directional control valve (30, 31), via which pressure medium can be supplied to a further hydraulic consumer and which is preferably combined with the first directional control valve to form a valve block (15), with a load indication line, via which a control side of a load-sensing regulating valve (51, 53) can be acted upon by a control pressure dependent on the highest load pressure of the actuated hydraulic consumer and which has a first line segment (40) nearest to the regulating valve (51, 53) and having the control pressure and at least one further line segment (41, 42, 43), in each case a line segment being connectable via a changeover valve (35, 36, 37, 38) to the following line segment or an individual indication duct (44, 45, 46, 47) of a directional control valve, and with a pilot valve arrangement, by means of which the control pressure is limited to a limit pressure, wherein in the case of a defined pressure occurring in a further line segment (42) of the load indication line, the pilot valve arrangement can be set from a high first limit pressure to a lower second limit pressure, and that, as seen from the first line segment (40) of the load indication line, the individual indication ducts (44, 45, 46, 47) can be connected to the successive line segments of the load indication line according to falling maximum load pressure of the hydraulic consumers.

23. The hydraulic control arrangement as claimed in claim 22, wherein the pilot valve arrangement can be adjusted hydraulically via a control line (64) which is connected to the further line segment (42) of the load indication line.

24. The hydraulic control arrangement as claimed in claim 22, wherein the pilot valve arrangement has a pilot valve (55) which is arranged between the first line segment (40) and a relief line (25), and the response pressure of which can be varied.

25. The hydraulic control arrangement as claimed in claim 24, wherein the pilot valve has a moveable valve element (56) acted upon by a valve spring (57) in the direction of a closing position, and by a pressure force at an active face in the direction of an opening position, and that the prestressing force of the valve spring (57) can be varied as a function of the pressure in the further line segment (42) of the load indication line.

26. The hydraulic control arrangement as claimed in claim 25, wherein the prestressing of the valve spring (57) can be varied via an auxiliary piston (58) between two values defined by a first fixed abutment (77) and a second fixed abutment (77, 81), the auxiliary piston (58) has an active face which is larger than the active face on the valve element (56) and which can be relieved of pressure or can be acted upon with pressure as a function of the switching position of a reversing valve (60, 85), said switching position being determined by the pressure in the further line segment (42) of the load indication line, and that the auxiliary piston (58) can be displaced up to the activation of the second abutment (77, 81) with the effect of increasing the spring prestress.

27. The hydraulic control arrangement as claimed in claim 26, wherein the two abutments (77, 81) are formed by two setscrews adjustable independently of one another.

28. The hydraulic control arrangement as claimed in claim 26, wherein the valve spring (57) can be supported via a spring plate (76) on the preferably screwed-in insert (77) which separates a spring space relieved of pressure from a control space (59) relieved of pressure or acted upon by pressure as a function of the position of the reversing valve (60, 85), and wherein the auxiliary piston (58), sealingly guided slideably in an axial bore of the insert (77), is arranged between the spring space and the control space (59), and that the spring plate (76) can be lifted off from the insert (77) by the auxiliary piston (58).

29. The hydraulic control arrangement as claimed in claim 28, wherein the valve spring (57) can be supported via a spring plate (76) on a first rotatable screwable insert (77) which forms the first abutment and which separates a spring space relieved of pressure from a control space (59) relieved of pressure or acted upon by pressure as a function of the position of the reversing valve (60, 85), wherein the auxiliary piston (58), sealingly guided slideably in an axial bore of the insert (77), is arranged between the spring space and the control space (59), and wherein on that side of the first screwable insert (77) which faces away from the spring space, is located a second rotatable screwable insert (81) which is preferably adjustable from outside and which forms the second abutment capable of being acted upon by the auxiliary piston (58).

30. The hydraulic control arrangement as claimed in claim 24, wherein the pilot valve (55) has a moveable element (56) acted upon by a valve spring (57) in the direction of a closing position, that the valve element (56) can be acted upon in the opening direction by a pressure occurring, downstream of a nozzle (50), in the first line segment (40) of the load indication line and at a first control face, and wherein there is a second control face on an auxiliary piston (58) which acts on the valve element (56) and which is relieved of pressure or can be acted upon by pressure as a function of the switching position of the reversing valve (60), said switching position being determined by the pressure in the further line segment (42) of the load indication line.

31. The hydraulic control arrangement as claimed in claim 30, wherein the valve element (56) is acted upon in the closing position by pressure occurring at the second control face, and that the second control face is smaller than the first control face.

32. The hydraulic control arrangement as claimed in claim 31, wherein a pressure-relieved spring space of the pilot valve (55) is sealed off, by means of an insert (77) preferably adjustable for varying the prestress of the valve spring (57), relative to a control space (59) relieved of pressure or acted upon by pressure, depending on the switching position of the reversing valve (60), and wherein an auxiliary piston (58) bearing against or firmly connected to the valve element (56) and having a cross-sectional face which is smaller than the first control face is sealingly guided slideably in a bore of the insert (77), said bore being open toward the control space (59).

33. The hydraulic control arrangement as claimed in claim 26, wherein the reversing valve is a 2/2-way directional control valve (60) and is arranged in series with a nozzle (61) between the load indication line and the relief line (25), and the control space (59) on the auxiliary piston (58) is connected to the connection between the nozzle (61) and 2/2-way directional control valve (60).

34. The hydraulic control arrangement as claimed in claim 26, wherein the reversing valve is a 3/2-way directional control valve (85) and connects a control space (59) on the auxiliary piston (58) to the load indication line in one switching position, and to a relief line (25) in the other switching position.

35. The hydraulic control arrangement as claimed in claim 22, wherein the pilot valve arrangement has a first pilot valve (55, 90) arranged between the first line segment (40) and a relief line (25) or connectable between these and a second pilot valve (86, 90) arranged between the load indication line and the relief line (25) or connectable between these, and wherein the response pressure of the second pilot valve (86, 90) is lower than the response pressure of the first pilot valve (55, 90).

36. The hydraulic control arrangement as claimed in claim 35, wherein the two pilot valves are pressure limiting valves (55, 86), and the second pilot valve (86) can be connected with its inlet to the first line segment (40) via a reversing valve (60) switchable as a function of the pressure occurring in a further line segment (42) of the load indication line.

37. The hydraulic control arrangement as claimed in claim 36, wherein the second pilot valve (86) is connected with its inlet, downstream of a nozzle (87), to a first further line segment (41), and the reversing valve (60), as a function of the pressure occurring in a further line segment (42) following the first further line segment (41) to the rear, connects or separates the first line segment (40) or an individual indication duct (44) connectable to the latter, downstream of a nozzle (50, 88) located in said indication duct, to or from the inlet of the second pilot valve (86).

38. The hydraulic control arrangement as claimed in claim 35, wherein the second pilot valve (90) is arranged between the first line segment (40) and a relief line (25), and wherein its moveable valve element can be acted upon in the closing direction by a valve spring (91) and in the opening direction by the pressure occurring in the further line segment (42, 43).

39. The hydraulic control arrangement as claimed in claim 22, wherein the pilot valve arrangement is assigned locally to a directional control valve (28) having a single-acting function.

40. The hydraulic control arrangement as claimed in claim 39, wherein the pilot valve arrangement has a pilot valve, whose pick-up pressure is changeable, and the pilot valve (55) is arranged with its axis in or parallel to a plane spanned by the axis of the directional control valve (28) and a working connection, preferably parallel to the axis of the directional control valve.

41. The hydraulic control arrangement as claimed in claim 40, wherein the pilot valve arrangement has a reversing valve, and the reversing valve (60) is arranged with its axis perpendicular to the plane.

42. The hydraulic control arrangement as claimed in claim 30, wherein the reversing valve is a 2/2-way directional control valve (60) and is arranged in series with a nozzle (61) between the load indication line and the relief line (25), and the control space (59) on the auxiliary piston (58) is connected to the connection between the nozzle (61) and 2/2-way directional control valve (60).

43. The hydraulic control arrangement as claimed in claim 30, wherein the reversing valve is a 3/2-way directional control valve (85) and connects a control space (59) on the auxiliary piston (58) to the load indication line in one switching position, and to a relief line (25) in the other switching position.
